(19) United States
(12) Patent Application Publication
(10) Pub. No.: US 2026/0114527 A1
(43) Pub. Date: Apr. 30, 2026

(54) Retention Apparatus with Single-Exit Anchored Drawstring

(71) Applicant: Mahdi Issa, Dayton, OH (US)

(72) Inventor: Mahdi Issa, Dayton, OH (US)

(21) Appl. No.: 19/346,622

(22) Filed: Oct. 1, 2025

Related U.S. Application Data
(60) Provisional application No. 63/713,115, filed on Oct. 29, 2024.

(51) Int. Cl. A41F 9/02; F16G 11/10

(52) U.S. Cl. CPC A41F 9/025; F16G 11/101

(57) ABSTRACT

A retention apparatus (i.e., waistband or neckband) for shorts, pants, sweatpants, bathing suits, swimming shorts, jackets, hoodies, sweatshirts, or similar garments. The garment includes a waistband or neckband casing formed as an elongated tubular channel extending circumferentially around an upper portion of the garment. A drawstring is disposed within the waistband casing, with a first end anchored to an interior portion of the waistband casing and a medial portion extending outwardly through a single exit opening to define an externally accessible free segment. The anchored first end prevents complete withdrawal of the drawstring and eliminates the disadvantages of conventional two-end drawstrings, or dual-ended drawstring. In use, a wearer selectively pulls the externally accessible segment to constrict the waistband, with elasticity and friction maintaining the adjusted tension during activity.

### CROSS-REFERENCE TO RELATED APPLICATION

The present application claims priority to, and the benefit of, U.S. Provisional Application No. 63/713,115 which was filed on Oct. 29, 2024 and is incorporated herein by reference in its entirety.

### FIELD OF THE INVENTION

The present invention generally is garments having adjustable waistbands. More specifically, the present invention is a waistband retention apparatus configured with a single-exit drawstring system designed to eliminate the shortcomings of conventional two-string drawstrings (i.e., a pair of free ends). The invention comprises a garment body, such as shorts, sweatpants, bathing suits, swimming shorts, jackets, hoodies, sweatshirts, or pants, having a retention band (i.e., waistband or neckband) casing formed as an elongated tubular channel extending circumferentially around the garment. A drawstring is disposed within the waistband casing, with a first end anchored to an interior portion of the waistband casing and a medial portion extending outwardly through a single exit aperture to form an externally accessible free segment. The user selectively pulls the free segment to constrict the waistband and secure the garment about the waist, while the anchored first end prevents complete withdrawal of the drawstring. The single-exit drawstring system is designed to prevent drawstring loss, simplify adjustment, and provide secure and reliable waistband tightening during use. Accordingly, the present disclosure makes specific reference thereto. Nonetheless, it is to be appreciated that aspects of the present invention are also equally applicable to other like applications, devices, and methods of manufacture.

### BACKGROUND

By way of background, standard gym shorts and similar athletic garments commonly include a waistband with a pair of drawstrings (or a two-ended drawstring) extending through the waistband casing. The drawstrings are intended to enable a user to tighten the garment securely around the waist. However, such two-string configurations present several drawbacks. Over time and with repeated use, one or both of the drawstrings can become displaced or inadvertently pulled back into the waistband casing. Once embedded within the waistband casing, the strings can be difficult or even impossible to retrieve.

In circumstances where the drawstring cannot be restored to its intended position, the user may be unable to adequately tighten the shorts to maintain them securely on the body. As a result, the garment may become unusable, forcing the user to purchase a replacement pair. Continually replacing shorts, sweatpants, bathing suits, swimming shorts, jackets, hoodies, sweatshirts, or pants due to lost or displaced drawstrings is inconvenient, unnecessarily costly, and a source of frustration to consumers. Accordingly, individuals desire an improved garment that eliminates use of the two strings that can become loosened and embedded within the garment.

Therefore, there exists a long-felt need in the art for a waistband retention apparatus that eliminates the shortcomings of conventional two-string drawstrings (i.e., a two-ended drawstring). There is a need for garments, such as gym shorts and pants, that include a simplified drawstring system which cannot be lost, pulled through, displaced, or embedded within the waistband casing. Further, there is a need in the art for a waistband system that provides secure and reliable tightening of the garment during physical activity without requiring the user to tie or knot two separate string ends. Additionally, there is a need for a waistband retention apparatus that maintains adjustability and comfort, while preventing the inconvenience and expense of replacing garments when drawstrings become lost or unusable. Finally, there exists a need for a drawstring solution that enhances reliability, improves usability, and extends the functional life of shorts and pants.

The subject matter disclosed and claimed herein, in one embodiment, comprises a waistband retention apparatus featuring a single-exit drawstring secured within a waistband casing. The apparatus includes a garment body, such as shorts, sweatpants, bathing suits, swimming shorts, jackets, hoodies, sweatshirts, or pants, and a retention band (i.e., waistband or neckband) casing extending circumferentially around an upper portion of the garment. A drawstring is disposed within the waistband casing, with a first end anchored to an interior portion of the waistband casing to prevent displacement or pull-throughs. A single exit opening is formed in the waistband casing, and a medial portion of the drawstring passes through the exit opening to define an externally accessible free segment. A user selectively pulls the free segment outwardly to constrict the waistband and tighten the garment about the wearer's waist, while the anchored first end prevents complete withdrawal of the drawstring.

In one embodiment, the first end of the drawstring is anchored to the interior portion of the waistband casing by reinforced stitching such as zig-zag or box stitches. In another embodiment, the drawstring comprises synthetic material such as nylon or polyester, wherein the first end is secured by heat-welding, adhesive bonding, or chemical bonding within the waistband casing. The anchored end ensures that the drawstring cannot be inadvertently pulled through the waistband casing and lost.

In this manner, the waistband retention apparatus of the present invention addresses longstanding shortcomings in conventional two-string drawstring (i.e., a pair of free ends) garment designs by enabling a secure and reliable waistband adjustment system. The invention enables users to maintain shorts, sweatpants, bathing suits, swimming shorts, jackets, hoodies, sweatshirts, or pants securely during exercise or other activities without concern for lost, pulled through, or embedded drawstrings. The apparatus integrates a single exit aperture and simple one-hand operation into a streamlined solution. The apparatus offers a reliable, frustration-free waistband system that enhances durability, functionality, and user confidence in activewear.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a waistband retention apparatus for a garment. The apparatus comprises a waistband casing that extends circumferentially around an upper portion of the garment, the waistband casing defining an elongated tubular channel. A drawstring is disposed within the waistband casing. A first end of the drawstring is secured to an interior portion of the waistband casing. A single exit opening is formed in the waistband casing, and the drawstring extends outwardly from the waistband casing only through the single exit opening to define an externally accessible free segment. When a user pulls on the externally accessible free segment, tension is selectively adjusted in the waistband casing to constrict the garment around a waist of the wearer, and the secured first end prevents displacement, pull-throughs, or loss of the drawstring within the waistband casing

In another embodiment, a garment is disclosed and comprises a waistband casing that is formed as a tubular channel extending circumferentially around an upper portion of the garment. A drawstring is routed within the waistband casing. An anchoring point is located at an interior portion of the waistband casing, and a first end of the drawstring is fixed at the anchoring point by at least one of stitching, adhesive bonding, heat-welding, or chemical bonding. A single exit aperture is formed in the waistband casing, and only a medial portion of the drawstring is externally accessible through the single exit aperture to define a free segment. When a user applies tension to the externally accessible free segment, circumferential constriction is applied to the waistband casing to tighten the garment around the wearer.

In one embodiment, a method of forming a waistband retention apparatus in a garment is described and comprises anchoring a first end of a drawstring to an interior portion of a waistband casing that extends circumferentially around an upper portion of the garment. The method further comprises routing a remaining portion of the drawstring through the waistband casing. The method further comprises providing a single exit opening in the waistband casing and extending a medial portion of the drawstring outward through the single exit opening to define an externally accessible free segment. In use, the method enables a wearer to pull on the externally accessible free segment to adjust tension in the waistband casing and constrict the waistband around the waist of the wearer, while the anchored first end prevents withdrawal or pull-throughs of the drawstring from the waistband casing.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front elevational view of a garment incorporating the waistband retention apparatus of the present invention in accordance with the disclosed structure;

FIG. 2 illustrates a cross-sectional view of the waistband casing of the waistband retention apparatus, showing the internal arrangement of the drawstring in accordance with the disclosed structure;

FIG. 3 illustrates a perspective view showing a user pulling the exposed segment of the drawstring to constrict the waistband of the garment in accordance with the disclosed structure;

FIG. 4 illustrates a flow chart depicting process of manufacturing the waistband retention apparatus of the present invention in accordance with the disclosed structure; and

FIG. 5 illustrates a front elevational view of a garment incorporating the retention apparatus of the present invention in accordance with another embodiment of the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a waistband retention apparatus that eliminates the shortcomings of conventional two-string drawstrings (i.e., a two-ended drawstring). There is a need for garments, such as gym shorts and pants, that include a simplified drawstring system which cannot be lost, pulled through, displaced, or embedded within the waistband casing. Further, there is a need in the art for a waistband system that provides secure and reliable tightening of the garment during physical activity without requiring the user to tie or knot two separate string ends. Additionally, there is a need for a waistband retention apparatus that maintains adjustability and comfort, while preventing the inconvenience and expense of replacing garments when drawstrings become lost or unusable. Finally, there exists a need for a drawstring solution that enhances reliability, improves usability, and extends the functional life of shorts and pants.

The present invention, in one exemplary embodiment, is a method of forming a waistband retention apparatus in a garment and comprises anchoring a first end of a drawstring to an interior portion of a waistband casing that extends circumferentially around an upper portion of the garment. The method further comprises routing a remaining portion of the drawstring through the waistband casing. The method further comprises providing a single exit opening in the waistband casing and extending a medial portion of the drawstring outward through the single exit opening to define an externally accessible free segment. In use, the method enables a wearer to pull on the externally accessible free segment to adjust tension in the waistband casing and constrict the waistband around the waist of the wearer, while the anchored first end prevents withdrawal of the drawstring from the waistband casing.

Reference will now be made in detail to the present preferred embodiments of the invention, examples of which are illustrated in the accompanying drawings. Wherever possible, the same reference numerals are used in the drawings and the description to refer to the same or like parts.

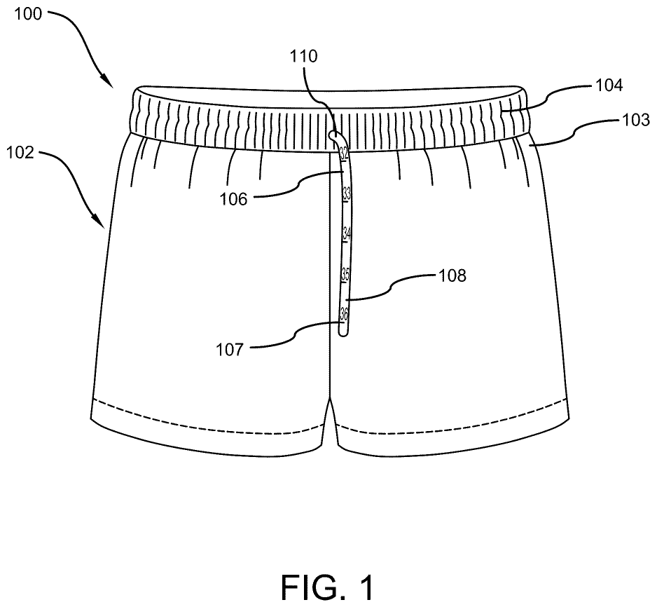

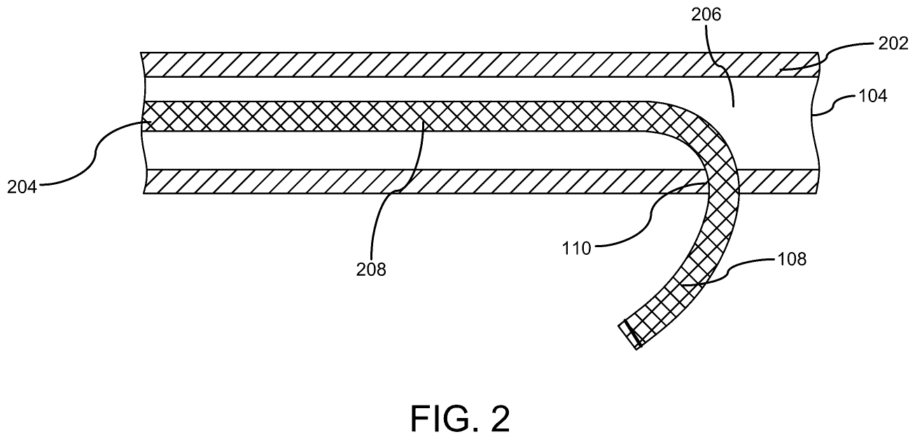

Referring initially to the drawings, FIG. 1 illustrates a front elevational view of a garment incorporating the waistband retention apparatus of the present invention in accordance with the disclosed structure. The waistband retention apparatus 100 of the present invention is designed for shorts and pants and specifically to eliminate two-string drawstrings (i.e., a pair of free ends). The garment 102 in the present embodiment is in the form of shorts and includes a waistband casing 104 extending circumferentially around an upper portion 103 of the garment 102. A drawstring 106 passes through and within the waistband casing 104. Unlike conventional two-end drawstrings or dual-ended drawstring, the illustrated embodiment provides only one externally accessible free segment 108. A first end 204 of the drawstring 106 is anchored/secured to an interior portion of the waistband casing 104 as illustrated in FIG. 2. The exposed externally accessible free segment 108 extends outward from a single exit aperture/opening 110 disposed in the waistband casing 104 to enable a user to selectively pull outwardly the externally accessible free segment 108 to adjust tension in the waistband casing 104, thereby constricting the waistband casing 104 around the waist of a wearer.

FIG. 2 illustrates a cross-sectional view of the waistband casing of the waistband retention apparatus, showing the internal arrangement of the drawstring in accordance with the disclosed structure. The waistband casing 104 is preferably defined by an elongated tubular channel extending circumferentially around the waistband 202. The drawstring 106 is disposed within the internal portion 206 of the waistband casing 104 and passes freely within the waistband casing 104. The drawstring 106 exits through the single exit opening 110. The first end 204 of the drawstring 106 is anchored to the interior portion 206 of the waistband casing 104, and the remaining length 208 of the drawstring 106 extends within the waistband casing 104 and outward through the exit opening 110, thereby providing an externally accessible segment 108 for waistband adjustment. The anchored/first end 204 of the drawstring 106 prevents complete withdrawal of the drawstring 106 from the waistband casing 104, thereby eliminating loss or entanglement of the drawstring within the waistband.

The first end 204 of the drawstring 106 can be sewn into the fabric of the waistband casing 104 using reinforced stitching such as zig-zag or box stitch. In some embodiments, the drawstring 106 is made of synthetic material such as nylon, polyester, and accordingly, the first end 204 can be heat-welded, chemically bonded, or adhesive bonded to the inside of the waistband casing 104.

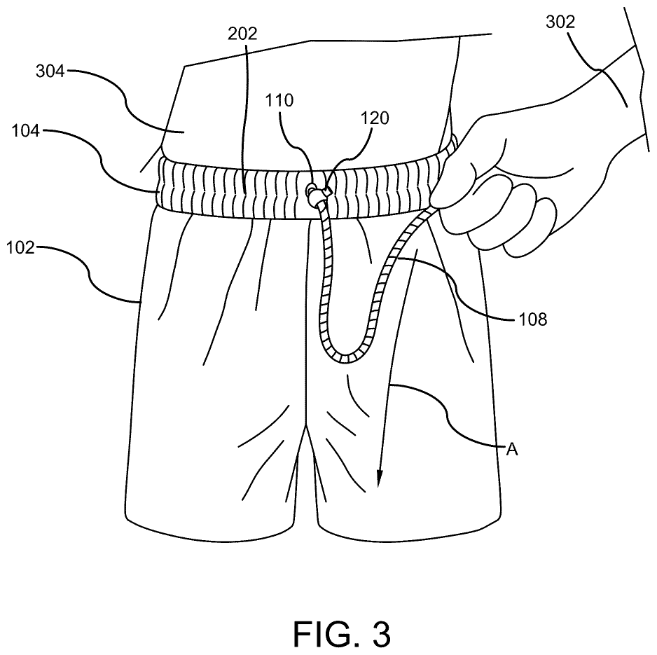

FIG. 3 illustrates a perspective view showing a user pulling the exposed segment of the drawstring to constrict the waistband of the garment in accordance with the disclosed structure. As shown, in use, the external segment 108 can be grasped and pulled down and/or out (as indicated by the directional arrow “A”) by a user using a single hand 302. The pulling action causes the drawstring 106 to retract within the waistband casing 104 and apply circumferential constriction to the waistband 202, thereby tightening the garment 102 securely around the user's waist 304. The waistband 202 can be selectively adjusted in tension by a single pulling motion while preventing loss, displacement, or pull-throughs of the drawstring from the waistband casing using the anchored/first end thereof (FIG. 2).

Once tension is applied to the externally accessible free segment 108 and subsequently released, the elasticity of the waistband casing 104 in combination with the frictional engagement between the drawstring 106 and the interior surfaces of the waistband casing 104 operates to hold the drawstring in place. Simultaneously with applying tension to the drawstring, or after applying tension to the drawstring, a single hole spring toggle stopper, a metal ring, a lockable hook, or drawstring cord lock 120 can be moved along the external segment 108 of the drawstring towards and adjacent to the exit opening 110. Once the drawstring cord lock 120 is adjacent exit opening 110, the drawstring cord lock 120 can be released to hold and lock the drawstring 106 in place and thereby hold or lock the desired tension of the drawstring 106. It is to be appreciated that the drawstring cord lock 120 can be made from a material selected from the group consisting of copper, aluminum, metal alloy, and plastic. The waistband 202 remains in a tightened configuration, thereby keeping the garment 102 securely positioned on the wearer during exercise or other physical activities. In one embodiment, the drawstring 106 comprises length markings (i.e., graduated markings) 107, for example, inch markings along the length of the drawstring 106 to indicate to the user the secured length of the drawstring 106. To relax or loosen the fit, the wearer may grasp and pull the waistband fabric away from the body, which reduces frictional engagement and enables the externally accessible free segment 108 to slacken and extend outwardly again through the single exit opening 110.

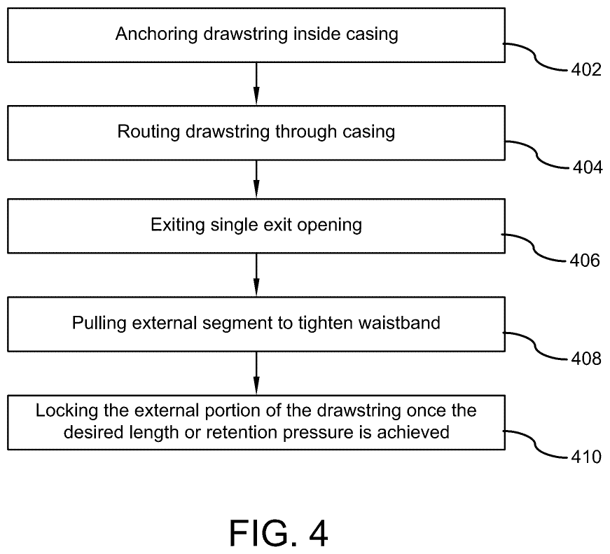

FIG. 4 illustrates a flow chart depicting process of using the retention band (i.e., waistband) apparatus of the present invention in accordance with the disclosed structure. Initially, depending on size of the waistband, the first end of the drawstring is anchored inside the waistband casing using one of sewing, adhesive, bonding, or stitching (Step 402). Then, the drawstring is routed through the waistband casing uniformly (Step 404) and a medial portion of the drawstring is taken out (i.e., exited) from the single exit opening or aperture (Step 406). In use, the external segment (medial portion exiting out from the opening) is pulled by a wearer to tighten the waistband (Step 408). Finally, the user can lock or clip (Step 410) the medial portion of the drawstring, for example onto the top edge of a pair of shorts, once the desired length or retention pressure is achieved.

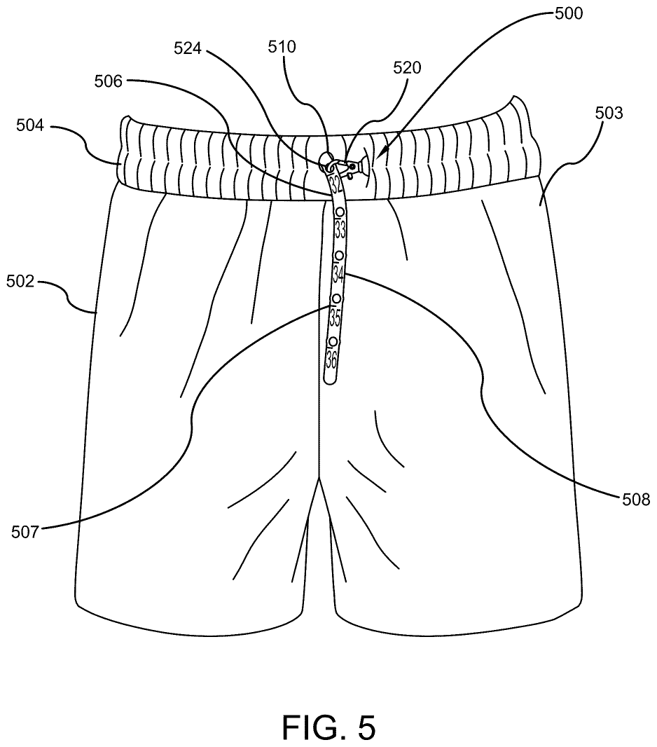

Referring to the drawings, FIG. 5 illustrates a front elevational view of a garment incorporating the retention apparatus of the present invention in accordance with another embodiment of the disclosed structure. The retention apparatus 500 of the present invention is designed for shorts, pants, sweatshirts, swim shorts, et. al., and specifically to eliminate two-string drawstrings (i.e., a pair of free ends). The garment 502 in the present embodiment is in the form of shorts and includes a waistband casing 504 extending circumferentially around an upper portion 503 of the garment 502. A drawstring 506 passes through and within the waistband casing 504. Unlike conventional two-end drawstrings or dual-ended drawstring, the illustrated embodiment provides only one externally accessible free segment 508. A first end of the drawstring 506 is anchored/secured to an interior portion of the waistband casing 504 (as described in FIG. 2). The exposed externally accessible free segment 508 extends outward from a single exit aperture/opening 510 disposed in the waistband casing 504 to enable a user to selectively pull outwardly the externally accessible free segment 508 to adjust tension in the waistband casing 504, thereby constricting the waistband casing 504 around the waist of a wearer. Simultaneously with applying tension to the drawstring, or after applying tension to the drawstring, a metal ring or cord lock hook 520 can be selectively hooked along the external segment 508 of the drawstring 506 towards and adjacent to the exit opening 510. With the metal ring 520 adjacent to exit opening 510, the metal ring 520 can be selectively hooked through an aperture 524 (i.e., selected from a plurality of apertures) in the free segment 508 of the drawstring 506 to hold or lock the desired tension of the drawstring 506. It is to be appreciated that the drawstring metal ring 520 can be made from a material selected from the group consisting of copper, aluminum, metal alloy, and plastic. The waistband casing 504 remains in a tightened configuration, thereby keeping the garment 502 securely positioned on the wearer during exercise or other physical activities. As shown, the drawstring 506 comprises length markings (i.e., graduated markings) 507, for example, inch markings along the length of the drawstring 506 to indicate to the user the secured length of the drawstring 506. To relax or loosen the fit, the wearer may unhook the metal ring 520 from the drawstring 506, grasp and pull the waistband fabric away from the body, which reduces frictional engagement and enables the externally accessible free segment 508 to slacken again through the single exit opening 510.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “waistband retention apparatus”, “garment waistband system”, “waistband retention apparatus with single-exit anchored drawstring”, and “apparatus” are interchangeable and refer to the waistband retention apparatus with single-exit anchored drawstring 100 of the present invention.

Notwithstanding the forgoing, the waistband retention apparatus with single-exit anchored drawstring 100 of the present invention can be of any suitable configuration as is known in the art without affecting the overall concept of the invention, provided that it accomplishes the above stated objectives. One of ordinary skill in the art will appreciate that the waistband retention apparatus with single-exit anchored drawstring 100 shown in the FIGS. are for illustrative purposes only, and that many other configurations of the waistband retention apparatus with single-exit anchored drawstring 100 are well within the scope of the present disclosure. Although the dimensions of the waistband retention apparatus with single-exit anchored drawstring 100 are important design parameters for user convenience, the waistband retention apparatus with single-exit anchored drawstring 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A waistband retention apparatus comprising:
a garment;
a waistband casing; and
a drawstring;
wherein said waistband casing extends circumferentially around an upper portion of said garment;
wherein said drawstring passes through and within said waistband casing;
wherein said drawstring consisting of one externally accessible free end segment;
wherein said drawstring consisting of one anchored end segment;
wherein said drawstring comprising graduated markings for determining a secured length of said drawstring; and
further wherein said one anchored end segment secured to an interior portion of said waistband casing.

2. The waistband retention apparatus of claim 1, wherein said one externally accessible free end segment extends outward from a single exit aperture of said waistband casing.

3. The waistband retention apparatus of claim 2, wherein said garment is selected from the group consisting of shorts, pants, jackets, sweatshirts, pants, and swimming shorts.

4. The waistband retention apparatus of claim 3, wherein said one externally accessible free end segment pullable outward from said waistband casing to adjust a tension in said waistband casing.

5. The waistband retention apparatus of claim 4, wherein said adjust a tension in said waistband casing constricts said waistband casing around a waist of a wearer of said garment.

6. The waistband retention apparatus of claim 5, wherein said waistband casing comprises an elongated tubular channel extending circumferentially around said upper portion of said garment.

7. The waistband retention apparatus of claim 6, wherein said one anchored end segment is sewn into an interior portion of said waistband casing.

8. The waistband retention apparatus of claim 6, wherein said one anchored end segment is adhered to an interior portion of said waistband casing, and further wherein said adhered is selected from the group consisting of heat-welding, chemical bonding, and adhesive bonding.

9. A waistband retention apparatus comprising:
a garment;
a waistband casing;
a drawstring; and
a drawstring cord lock;
wherein said waistband casing extends circumferentially around an upper portion of said garment;
wherein said drawstring passes through and within said waistband casing;
wherein said drawstring consisting of one externally accessible free end segment;
wherein said drawstring consisting of one anchored end segment;
wherein said one anchored end segment secured to an interior portion of said waistband casing;
wherein said one externally accessible free end segment extends outward from a single exit aperture of said waistband casing;
wherein said one externally accessible free end segment pullable outward from said waistband casing and secured with said drawstring cord lock to adjust and hold a tension in said waistband casing;
wherein said adjust a tension in said waistband casing constricts said waistband casing around a waist of a wearer of said garment;
wherein said one anchored end segment is adhered to an interior portion of said waistband casing; and
further wherein said adhered is selected from the group consisting of heat-welding, chemical bonding, adhesive bonding, and stitching.

10. The waistband retention apparatus of claim 9, wherein said garment is selected from the group consisting of shorts, pants, jackets, sweatshirts, pants, and swimming shorts.

11. The waistband retention apparatus of claim 9, wherein said waistband casing comprises an elongated tubular channel extending circumferentially around said upper portion of said garment.

12. A method of selectively retaining a garment retention band around a wearer, the method comprising the steps of:
providing a garment, a retention band casing, a drawstring, and a drawstring cord lock;
extending circumferentially said retention band casing around an upper portion of said garment, wherein said drawstring passes through and within said retention band casing, wherein said drawstring consisting of one externally accessible free end segment and further wherein said drawstring consisting of one anchored end segment;
adhering said one anchored end segment to an interior portion of said retention band casing;
securing said one anchored end segment to an interior portion of said retention band casing;
pulling with one hand said one externally accessible free end segment to constrict a retention band of said garment;
retracting said drawstring within said retention band casing;
selectively adjusting a tension by said one hand pulling of said one externally accessible free end segment; and
locking the tension of said drawstring with said drawstring cord lock.

13. The method of selectively retaining a garment retention band around a wearer of claim 12 further comprising a step of grasping and pulling said upper portion of said garment away from the body of the wearer to reduce frictional engagement of said retention band casing and said drawstring.

14. The method of selectively retaining a garment retention band around a wearer of claim 12, wherein said one externally accessible free end segment extends outward from a single exit aperture of said retention band casing.

15. The method of selectively retaining a garment retention band around a wearer of claim 12, wherein said garment is selected from the group consisting of shorts, pants, bathing suits, swimming shorts, sweatshirts, jackets, pants, and hoodies.

16. The method of selectively retaining a garment retention band around a wearer of claim 12, wherein said one externally accessible free end segment pullable outward from said retention band casing for said adjusting said tension in said retention band casing.

17. The method of selectively retaining a garment retention band around a wearer of claim 12, wherein said adjusting said tension in said retention band casing constricts said retention band casing around a body portion of a wearer of said garment.

18. The method of selectively retaining a garment retention band around a wearer of claim 12, wherein said retention band casing comprises an elongated tubular channel extending circumferentially around said upper portion of said garment.

19. The method of selectively retaining a garment retention band around a wearer of claim 12, wherein said one anchored end segment is sewn into an interior portion of said retention band casing.

20. The method of selectively retaining a garment retention band around a wearer of claim 12, wherein said one anchored end segment is adhered to an interior portion of said retention band casing, and further wherein said adhered is selected from the group consisting of heat-welding, chemical bonding, and adhesive bonding.
